(19) United States
(12) Patent Application Publication
(10) Pub. No.: US 2016/0104937 A1
(43) Pub. Date: Apr. 14, 2016

(54) COIL MODULE, ANTENNA DEVICE, AND ELECTRONIC DEVICE

(71) Applicant: DEXERIALS CORPORATION, Tokyo (JP)

(72) Inventors: Tatsuo KUMURA, Tochigi (JP); Yusuke KUBO, Tochigi (JP); Hiroyuki RYOSON, Tochigi (JP)

(21) Appl. No.: 14/777,659

(22) PCT Filed: Mar. 11, 2014
(86) PCT No.: PCT/JP2014/056312

§ 371 Date: Sep. 16, 2015

(30) Foreign Application Priority Data
Mar. 19, 2013 (JP) 2013-056045

(51) Int. Cl. H01Q 7/06; G06K 19/077; H02J 7/02; H01Q 1/38; H01Q 1/22

(52) U.S. Cl. CPC H01Q 7/06; H01Q 1/38; H01Q 1/2208; H02J 7/025; G06K 19/07773

(57) ABSTRACT

Provided is a coil module which is reduced in size and made slimmer by incorporating a material and structure resistant to magnetic saturation. The coil module has: a magnetic resin layer containing magnetic particles; and a spiral coil, wherein the magnetic resin layer contains magnetic particles having a spherical shape or a spheroid shape having a dimensional ratio of not more than 6, the dimensional ratio being expressed as a ratio of the major diameter to the minor diameter.

### BACKGROUND OF THE INVENTION

1. Field of the Invention

The present invention relates to a coil module comprising a spiral coil and a magnetic shield layer made up of a magnetic shield material, particularly relates to a coil module having a magnetic resin layer containing magnetic particles as a magnetic shield layer, and relates to an antenna device and an electronic device each including this coil module. The present application claims priority based on Japanese Patent Application No. 2013-056045 filed in Japan on Mar. 19, 2013. The total contents of the Patent Application are to be incorporated by reference into the present application.

2. Description of Related Art

Recent wireless communication devices are equipped with a plurality of RF antennas, such as an antenna for telephone communication, an antenna for GPS, an antenna for wireless LAN/BLUETOOTH (registered trademark), and RFID (Radio Frequency Identification). In addition to these antennas, with the introduction of non-contact charging, the wireless communication devices have been equipped also with an antenna coil for power transfer. Examples of a power transfer system which is used in the mode of a non-contact charging system include an electromagnetic induction system, a radio wave receiving system, and a magnetic resonance system. Any of these systems makes use of electromagnetic induction or magnetic resonance between a primary coil and a secondary coil, and, the foregoing RFID also makes use of electromagnetic induction.

Although these antennas are designed so as to exhibit the maximum characteristics at a target frequency on a stand-alone basis, when the antennas are practically mounted on electronic devices, it is difficult to attain target characteristics. This is because a magnetic field component in the perimeter of an antenna interferes with (is coupled to) a metal and the like which lie therearound, and the inductance of an antenna coil substantially decreases, and therefore a shift in resonance frequency is caused. Furthermore, the substantial decrease in inductance causes a decrease in receiving sensitivity. As a measure against these problems, a magnetic shield material is interposed between an antenna coil and a metal present around the coil, whereby a magnetic flux generated from the antenna coil is collected in the magnetic shield material, thereby making possible a reduction in interference by the metal.

### PRIOR-ART DOCUMENTS

### Non-Patent Documents

Non-patent document 1: Ishimine, Watanabe, Ueno, Maeda, and Tokuoka, “Development of Low-Iron-Loss Powder Magnetic Core Material for High-Frequency Applications”, SEI Technical Review, January 2011, No. 178, pp. 121-127.

Non-patent document 2: Wireless Power Consortium, “System Description Wireless Power Transfer”, Volume I: Low Power, Part 1: Interface definition, Version 1.1.1, July 2012.

### BRIEF SUMMARY OF THE INVENTION

### Problems to be Solved by the Invention

Generally, a magnetic shield material, which is used for non-contact communication and non-contact charging, exhibits excellent shielding performance when having high magnetic permeability, and therefore, mainly, ferrite and metal magnetic foil which each have high magnetic permeability have been used as magnetic shield materials. However, when these magnetic shield materials are used under an environment in which a strong direct-current magnetic field is applied, a magnetic substance goes into magnetic saturation, whereby effective magnetic permeability thereof decreases. For example, Non-patent document 1 reports that, in a ferrite core, a direct-current bias characteristic is considerably degraded due to magnetic saturation. Furthermore, usually, metal magnetic foil having a high saturation magnetic flux density has a small thickness, namely several tens of micrometers, and therefore, unless several tens of sheets of the foil are put in layers when used, a magnetic saturation problem arises likewise.

As for electromagnetic induction type non-contact charging, in Wireless Power Consortium (WPC), a transmitting coil unit equipped with a magnet is stipulated (Design A1, described in Non-patent document 2), and has been already on the market. In the case where a thin coil unit is produced, the thickness of a magnetic shield needs to be small, but, at this time, the foregoing magnetic saturation is notably caused, whereby the inductance of a coil greatly decreases. Consequently, a resonance frequency on a power receiving coil side is considerably shifted, whereby problems arise that transmission efficiency of transmission power from a primary side to a secondary side decreases and heat generation in a power receiving coil increases. Furthermore, in the case where a shift in resonance frequency is significant, another problem arises that the transmission itself cannot be made.

Hence, an object of the present invention is to provide a coil module which is reduced in size and made slimmer by incorporating a material and a structure which are resistant to magnetic saturation.

### Means to Solve the Problem

To solve the foregoing problems, a coil module according to the present invention comprises a magnetic shield layer including a magnetic material and a spiral coil. The magnetic shield layer has at least one magnetic resin layer containing magnetic particles. Furthermore, the magnetic resin layer contains magnetic particles having a spherical shape or a spheroid shape having a dimensional ratio of the major diameter to the minor diameter of not more than 6.

To solve the foregoing problems, an antenna device according to the present invention comprises a coil module having a magnetic shield layer containing a magnetic material and a spiral coil. The magnetic shield layer of the coil module has at least one magnetic resin layer containing magnetic particles. Furthermore, the magnetic resin layer contains magnetic particles having a spherical shape or a spheroid shape having a dimensional ratio of the major diameter to the minor diameter of not more than 6.

To solve the foregoing problems, an electronic device according to the present invention comprises a coil module having a magnetic shield layer containing a magnetic material and a spiral coil. The magnetic shield layer of the coil module has at least one magnetic resin layer containing magnetic particles. Furthermore, the magnetic resin layer contains magnetic particles having a spherical shape or a spheroid shape having a dimensional ratio of the major diameter to the minor diameter of not more than 6.

### Effects of Invention

The coil module according to the present invention has the magnetic resin layer which is provided in the whole or part of the magnetic shield layer and whose magnetic characteristics are less prone to degradation due to magnetic saturation, and therefore, even under an environment in which a strong direct-current magnetic field is applied, coil inductance does not vary greatly and stable communication can be made.

The antenna device according to the present invention has the magnetic resin layer which is provided in the whole or part of the magnetic shield layer and whose magnetic characteristics are less prone to degradation due to magnetic saturation, and therefore, even under an environment in which a strong direct-current magnetic field is applied, coil inductance does not vary greatly and stable communication can be made.

The electronic device according to the present invention has the magnetic resin layer which is provided in the whole or part of the magnetic shield layer and whose magnetic characteristics are less prone to degradation due to magnetic saturation, and therefore, even under an environment in which a strong direct-current magnetic field is applied, coil inductance does not vary greatly and stable communication can be made.

### BRIEF DESCRIPTION OF THE SEVERAL VIEWS OF THE DRAWINGS

FIG. 1A is a plan view of a coil module according to an embodiment of the present invention. FIG. 1B is a cross-sectional view taken along line AA′ in FIG. 1A.

FIG. 2A is a plan view of a coil module according to a modification example of the embodiment of the present invention. FIG. 2B is a cross-sectional view taken along line AA′ in FIG. 2A.

FIG. 3A is a plan view of a coil module according to another modification example of the embodiment of the present invention. FIG. 3B is a cross-sectional view taken along line AA′ in FIG. 3A.

FIG. 4A is a plan view of a coil module according to another embodiment of the present invention. FIG. 4B is a cross-sectional view taken along line AA′ in FIG. 4A.

FIG. 5 is a block diagram illustrating a configuration example of a non-contact communication system adopting a coil module.

FIG. 6 is a block diagram illustrating a principal portion of a resonant circuit.

FIG. 7 is a block diagram illustrating a configuration example of a non-contact communication system adopting a coil module.

FIG. 8A and FIG. 8B are side views illustrating the configurations of a coil module for characteristics evaluation according to the present invention. FIG. 8A is a side view illustrating the configuration of the coil module only, and FIG. 8B is a side view illustrating the coil module together with a transmitting coil unit provided with a magnet which produces a direct-current magnetic field.

FIG. 9A and FIG. 9B are graphs on which ΔL obtained with varying the thickness of a magnetic shield layer is plotted, where ΔL represents a relative value of inductance which is a inductance variation value of a coil in the case of applying a direct-current magnetic field relative to an inductance value of the coil in the case of not applying a direct-current magnetic field. FIG. 9A shows ΔL in the case where spherical amorphous alloy is used for a magnetic resin layer to attain a relative permeability of approximately 20, and FIG. 9B shows ΔL in the case where spherical sendust is used for a magnetic resin layer to attain a relative permeability of approximately 15.

FIG. 10A and FIG. 10B are graphs of comparative examples on which relative values of inductance, ΔL, obtained with varying the thickness of a magnetic shield layer are plotted. FIG. 10A shows ΔL in the case where sendust having a dimensional ratio of the major diameter to the minor diameter of approximately 50 is used for a magnetic shield layer to attain a relative permeability of approximately 100, and FIG. 10B shows ΔL in the case where Mn—Zn ferrite is used for a magnetic shield layer to attain a relative permeability of approximately 1500.

FIG. 11A and FIG. 11B are graphs showing the results of measuring the difference in inductance value in the case where a magnetic layer is added to a magnetic resin layer. FIG. 11A is a graph on which measured values of inductance are plotted relative to the thickness of a magnetic shield layer in the case where a direct-current magnetic field is absent, and FIG. 11B a graph on which measured values of inductance are plotted relative to the thickness of a magnetic shield layer in the case where a direct-current magnetic field is present.

### DETAILED DESCRIPTION OF THE INVENTION

Hereinafter, embodiments of the present invention will be described in detail with reference to the drawings. It should be noted that the present invention is not limited only to the following embodiments, and it is a matter of course that various modifications can be made within the scope not deviating from the gist of the present invention.

### First Embodiment

<Configuration of Coil Module>

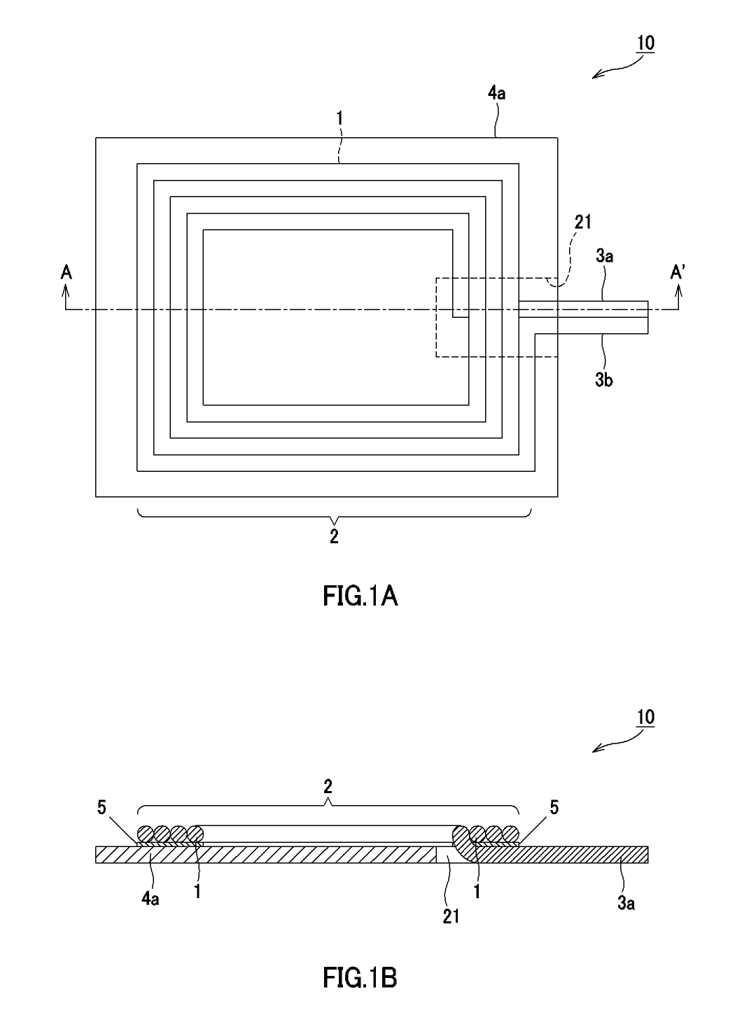

As illustrated in FIG. 1A and FIG. 1B, a coil module 10 comprises: a spiral coil 2 formed of a lead wire 1 spirally wound; and a magnetic resin layer 4a made of resin containing magnetic particles. The spiral coil 2 has drawn-out portions 3a and 3b at the respective ends of the lead wire 1, and the drawn-out portions 3a and 3b are connected to a rectifier circuit and the like, thereby constituting a secondary circuit of a non-contact charging circuit. As illustrated in FIG. 1B, the drawn-out portion 3a on the inside diameter side of the spiral coil 2 passes through below the underside of the lead wire 1 and is drawn out toward the outside diameter side of the spiral coil 2 through a notch portion 21 provided in the magnetic resin layer 4a so that the drawn-out portion 3a intersects the lead wire 1.

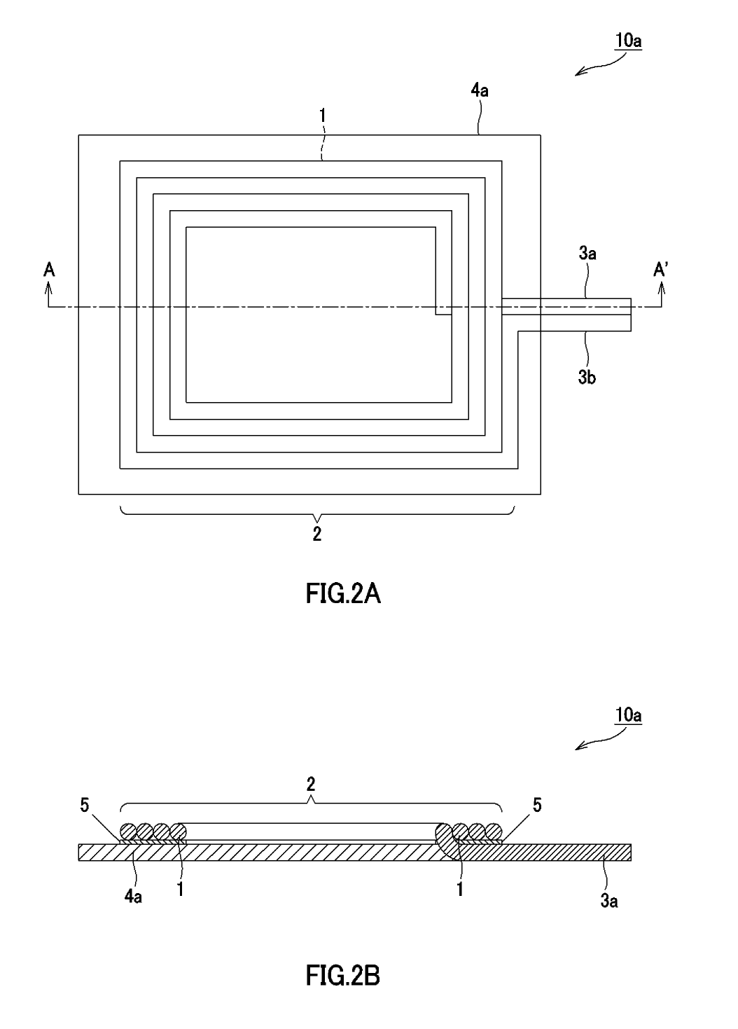

As illustrated in FIG. 2A and FIG. 2B, in a coil module 10a, in accordance with a later-mentioned production process, a spiral coil 2 may be so mounted before curing of a magnetic resin layer 4a as to bury a drawn-out portion 3a in the magnetic resin layer 4a.

It should be noted that, as illustrated in FIG. 1A and the like, the spiral coil 2 is formed to exhibit a rectangular shape, but, as a matter of course, the spiral coil 2 may be formed in a round shape, an elliptical shape, or an arbitrary shape, and also a magnetic shield layer made up of the magnetic resin layer 4a and the like may have a plane in an arbitrary shape.

The magnetic resin layer 4a may contain magnetic particles made of a soft magnetic powder and a resin as a binding material. The magnetic particles are particles of an oxide magnetic substance such as ferrite; particles of an Fe, Co, Ni, Fe—Ni, Fe—Co, Fe—Al, Fe—Si, Fe—Si—Al, Fe—Ni—Si—Al, or the like crystalline or microcrystalline metal magnetic substance; or particles of an Fe—Si—B, Fe—Si—B—Cr, Co—Si—B, Co—Zr, Co—Nb, Co—Ta, or the like amorphous metal magnetic substance. Besides the foregoing magnetic particles, the magnetic resin layer 4a may contain a filler to improve thermal conductivity, a particle filling property, and the like.

As the magnetic particles used for the magnetic resin layer 4a, there is employed a powder having a particle diameter of a few μm to 200 μm inclusive, having a spherical shape or a slender (cigar-like) or flat (disc-like) spheroid shape having a dimensional ratio (the major diameter/the minor diameter) of not more than 6. Here, as the magnetic particles, not only a single magnetic powder, but also a mixture of powders having different powder diameters, different materials, or different dimensional ratios may be employed. Particularly, in the case where the metal magnetic particles out of the foregoing magnetic particles are employed, complex magnetic permeability of the metal magnetic particles has a frequency property, and accordingly, a higher clock frequency causes a loss by a skin effect, and therefore, the particle diameter and shape are adjusted in accordance with a band range of frequency to be used. Furthermore, the particle shape of the magnetic resin layer 4a is a spherical shape or a spheroid shape having a small dimensional ratio, and the shape leads to a large demagnetizing factor and rarely causes saturation in a magnetic field from the outside. These particles having a large demagnetizing factor constitute the magnetic resin layer 4a via a resin, and therefore, even under an environment in which a large magnetic field is present, magnetic characteristics which are less affected by magnetic saturation are exhibited.

Furthermore, the magnetic resin layer 4a is formed by kneading magnetic particles and resin and has a moderate pliability even after being cured, and therefore, can be processed so as to fit the shape of the inside of a casing of an electronic device, and mounted on the device.

An inductance value of the coil module 10 is determined by the real part average magnetic permeability (hereinafter, simply referred to as average magnetic permeability) of the magnetic resin layer 4a, and this average magnetic permeability can be adjusted by a mixing ratio of a magnetic powder to a resin. Generally, the relationship between the average magnetic permeability of the magnetic resin layer 4a and the magnetic permeability of a magnetic powder to be blended follows the logarithmic mixing law to a blending amount, and hence, the filling factor of a magnetic powder is preferably a volume filling factor of not less than 40 vol % which allows an increase in interaction between particles. It should be noted that thermal conductivity of the magnetic resin layer 4a is improved with an increase in the filling factor of a magnetic powder, and therefore, in order to increase the filling factor of a magnetic powder, as the magnetic resin layer 4a, there may be employed a dust core which is obtained by applying compression molding to a mixture of a metal magnetic powder, a resin, a lubricant, and the like.

As a binder, a resin which can be cured by heat, ultraviolet irradiation, or the like is used. As the binder, there may be used a well-known material, for example, resin, such as epoxy resin, phenol resin, melamine resin, urea resin, or unsaturated polyester resin, or rubber, such as silicone rubber, urethane rubber, acrylic rubber, butyl rubber, or ethylene propylene rubber. As a matter of course, the binder is not limited to these materials. It should be noted that the binder may be formed by adding an appropriate amount of a surface treatment agent, such as a flame retardant, a reaction regulator, a crosslinking agent, or a silane coupling agent, to the foregoing resin or rubber.

In the case where a charging output capacitance is approximately 5 W and the lead wire 1 of which the spiral coil 2 is formed is made use of at a frequency of approximately 120 kHz, as the lead wire 1, there may be preferably used a single wire having a diameter of 0.20 mm to 0.45 mm inclusive and made of Cu or an alloy containing Cu as a principal component. Alternatively, in order to reduce the skin effect of the lead wire 1, there may be used a parallel or braided wire obtained by bundling a plurality of wires each being thinner than the foregoing single wire, or, there may be used a rectangular or flat wire having a small thickness to form a single- or double-layer a-winding.

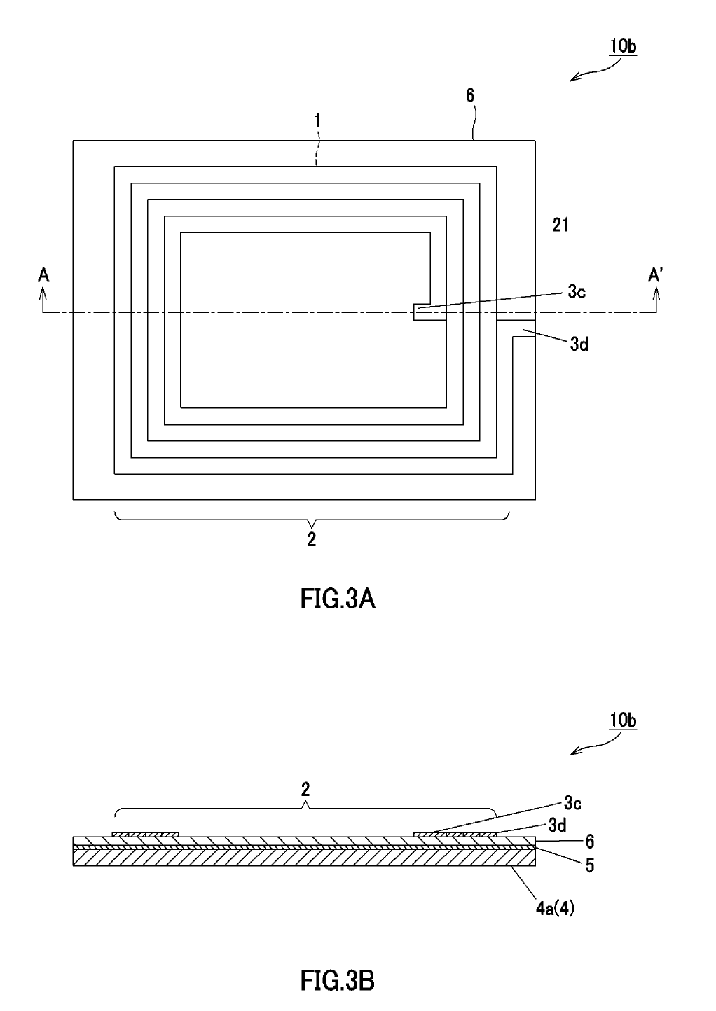

Furthermore, to make a coil portion thinner, an FPC (Flexible printed circuit) coil produced by patterning a conductor on one side or both sides of a substrate made up of a dielectric material may be used as the spiral coil 2. That is, as illustrated in FIG. 3A and FIG. 3B, a coil module 10b comprises the spiral coil 2 formed by spirally patterning the lead wire 1 made up of an electric conductor on one side of a substrate 6 made up of a dielectric material; and a magnetic resin layer 4a made of a resin containing magnetic particles. At the both ends of the lead wire, terminal portions 3c and 3d to establish connection with an external circuit are provided, respectively. Pattern wiring of the lead wires 1 is provided on both sides of the substrate 6, and the lead wires 1 on the both sides are serially connected to each other via a through hole, whereby the number of turns can be increased. Alternatively, the lead wires 1 patterned on the both sides are connected to each other in parallel via a through hole, whereby current-carrying capacity can be increased. The use of a multilayer substrate as a substrate makes further multi-layering possible, and multilayer wiring makes it possible to achieve a further increase in the number of turns and current-carrying capacity.

The spiral coil 2 is connected to the magnetic shield layer 4 via an adhesive layer 5. As the adhesive layer 5, there may be used a well-known material, for example, resin, such as epoxy resin, phenol resin, melamine resin, urea resin, or unsaturated polyester resin, or rubber, such as silicone rubber, urethane rubber, acrylic rubber, butyl rubber, or ethylene propylene rubber. The adhesive layer 5 may be formed by being directly applied to the magnetic shield layer 4, or alternatively, may be formed by sticking a double-sided-tape-like material having adhesive layers formed on both sides of a base material, to the magnetic shield layer 4.

<Production Method of Coil Module>

First, a sheet of a magnetic resin layer 4a is produced. A material obtained by kneading a magnetic powder and a binder, such as resin or rubber, is applied onto a sheet made of PET or the like and having undergone release processing, and a not-yet-cured sheet having a predetermined thickness is obtained using the doctor blade method or the like.

After that, heating or a pressurizing and heating treatment is applied to complete a sheet of a magnetic shield layer made up of a cured magnetic resin layer 4a. For this sheet production, there may be employed an extrusion process, and furthermore, there may be employed a process of pouring a kneaded material obtained by kneading raw materials of the sheet, namely, a magnetic powder and a binder or the like, into a mold, an injection molding process, or the like.

Next, an adhesive layer 5 is formed on the foregoing sheet, and a spiral coil 2 is placed thereon at a predetermined position, and then, the spiral coil 2 is pressed from above at a certain pressure to complete a coil module 10. In the case where the adhesive layer 5 is mainly made up of a thermosetting-type binder, heat treatment is applied at the time of pressurization. That is, joining of the foregoing sheet and the spiral coil 2 by the adhesive layer 5 is completed by adding a condition for curing the binder of the adhesive layer 5 at the time of pressurization or after pressurization. It is only required that the adhesive layer 5 is formed in an area in which the foregoing sheet comes into contact with the spiral coil 2, but, unless any trouble is caused, the adhesive layer 5 may be formed in a part or the whole, including the foregoing area, of a surface of the foregoing sheet. Furthermore, in the foregoing example, the adhesive layer 5 is formed on a sheet side, but may be formed on a spiral coil 2 side and joined to the foregoing sheet.

### Second Embodiment

<Configuration of Coil Module>

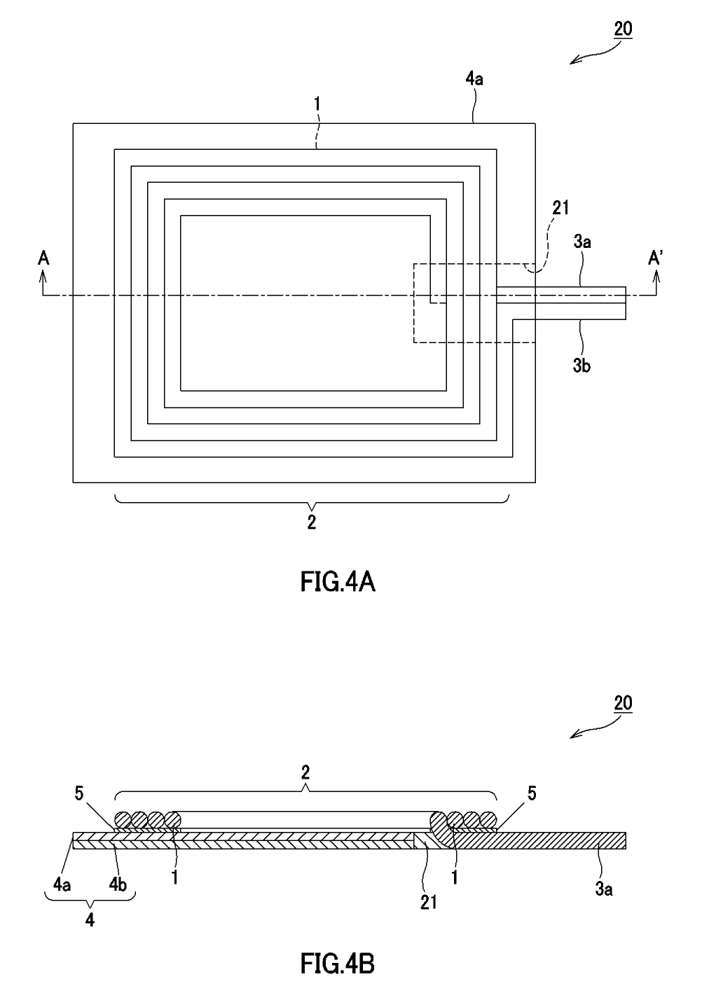

As illustrated in FIG. 4A and FIG. 4B, a coil module 20 of the present invention comprises: a spiral coil 2 formed of a lead wire 1 spirally wound; a magnetic resin layer 4a made of resin containing magnetic particles; and a magnetic layer 4b. The spiral coil 2 has drawn-out portions 3a and 3b at the respective ends of the lead wire 1, and the drawn-out portions 3a and 3b are connected to a rectifier circuit and the like, thereby constituting a secondary circuit of a non-contact charging circuit. As illustrated in FIG. 4B, the drawn-out portion 3a on the inside diameter side of the spiral coil 2 is drawn out toward the outside diameter side of the spiral coil 2 through a notch portion 21 provided in the magnetic resin layer 4a and the magnetic layer 4b so that the drawn-out portion 3a intersects the lead wire 1. In FIG. 4, the notch portion 21 is formed in the magnetic resin layer 4a and the magnetic layer 4b, but, as is the case with the first embodiment, without provision of a notch portion, the drawn-out portion 3a may be buried in the magnetic resin layer 4a or the magnetic layer 4b, or in both of the magnetic resin layer 4a and the magnetic layer 4b.

The magnetic resin layer 4a and the magnetic layer 4b may contain magnetic particles made of a soft magnetic powder and a resin as a binding material. The magnetic particles are particles of an oxide magnetic substance such as ferrite; particles of an Fe, Co, Ni, Fe—Ni, Fe—Co, Fe—Al, Fe—Si, Fe—Si—Al, Fe—Ni—Si—Al, or the like crystalline or microcrystalline metal magnetic substance; or particles of an Fe—Si—B, Fe—Si—B—C, Co—Si—B, Co—Zr, Co—Nb, Co—Ta, or the like amorphous metal magnetic substance.

As the magnetic particles used for the magnetic resin layer 4a, there is employed a powder having a particle diameter of a few μm to 200 μm inclusive, having a spherical shape or a slender (cigar-like) or flat (disc-like) spheroid shape having a dimensional ratio (the major diameter/the minor diameter) of not more than 6, and, not only a single magnetic powder, but also a mixture of powders having different powder diameters, different materials, or different dimensional ratios may be employed. Furthermore, the particle shape of the magnetic resin layer 4a is a spherical shape or a spheroid shape having a small dimensional ratio, and the shape leads to a large demagnetizing factor and rarely causes saturation in a magnetic field from the outside. These particles having a large demagnetizing factor constitute the magnetic resin layer 4a via a resin, and therefore, even under an environment in which a large magnetic field is present, magnetic characteristics which are less affected by magnetic saturation are exhibited.

For the magnetic layer 4b, there may be used a metal magnetic substance having high magnetic permeability, such as sendust, permalloy, or amorphous; Mn—Zn ferrite; Ni—Zn ferrite; or a green compact molding material which is produced by adding a small amount of a binder to magnetic particles used for the magnetic resin layer 4a and performing compression molding. Furthermore, the magnetic layer 4b may be a magnetic resin layer which is highly filled with magnetic particles. The magnetic layer 4b is provided in order to further increase an inductance value of a coil, and the average magnetic permeability of the magnetic layer 4b is designed to be larger than that of the magnetic resin layer 4a. As long as a magnetic substance can allow such relationship to be kept, regardless of the kind, shape, size, structure, and the like of the magnetic substance, the magnetic substance can be employed as the magnetic layer 4b.

The magnetic layer 4b is provided in order to improve magnetic shield performance and effectively increase the inductance value of a coil. Therefore, in the example illustrated in FIG. 4A and FIG. 4B, the magnetic layer 4b is provided on a surface of the magnetic resin layer 4a, the surface opposite to a surface on which the spiral coil 2 is mounted, but, may be disposed on the magnetic resin layer 4a so as to be sandwiched between the spiral coil 2 and the magnetic resin layer 4a. Alternatively, the magnetic layer 4b may be such that a part or the whole of the magnetic layer 4b is buried in the magnetic resin layer 4a.

As a binder, a resin which can be cured by heat, ultraviolet irradiation, or the like is used. As the binder, there may be used a well-known material, for example, resin, such as epoxy resin, phenol resin, melamine resin, urea resin, or unsaturated polyester resin, or rubber, such as silicone rubber, urethane rubber, acrylic rubber, butyl rubber, or ethylene propylene rubber. As a matter of course, the binder is not limited to these materials. It should be noted that the binder may be formed by adding an appropriate amount of a surface treatment agent, such as a flame retardant, a reaction regulator, a crosslinking agent, or a silane coupling agent, to the foregoing resin or rubber.

In the case where a charging output capacitance is approximately 5 W and the lead wire 1 of which the spiral coil 2 is formed is made use of at a frequency of approximately 120 kHz, as the lead wire 1, there may be preferably used a single wire having a diameter of 0.20 mm to 0.45 mm inclusive and made of Cu or an alloy containing Cu as a principal component. Alternatively, in order to reduce the skin effect of the lead wire 1, there may be used a parallel or braided wire obtained by bundling a plurality of wires each being thinner than the foregoing single wire, or, there may be used a rectangular or flat wire having a small thickness to form a single- or double-layer α-winding. Furthermore, to make a coil portion thinner, an FPC (Flexible printed circuit) coil produced by patterning a conductor on one side or both sides of a dielectric substrate may be used.

It should be noted that, in the description above, the foregoing coil module has one spiral coil 2, but the coil module is not limited to this, and, for example, the coil module may be configured such that another antenna module may be provided on the inside diameter side or the outside diameter side of the coil module. Furthermore, the foregoing coil module is applicable to an antenna unit for non-contact electric-power transfer (non-contact charging), and can be mounted on various electronic devices.

### Specific Example of Configuration for Non-Contact Communication System and Non-Contact Charging System

<Configuration Example of Non-Contact Communication Device>

As a resonant coil (antenna), the coil module 10 according to one embodiment of the present invention constitutes a resonant circuit, together with a resonant capacitor, and an antenna device comprises the resonant circuit. The constituted antenna device is mounted on a non-contact communication device to carry out non-contact communications between the non-contact communication device and another non-contact communication device. The non-contact communication device is, for example, a non-contact communication module 150, such as NFC (Near Field Communication) mounted on a cellular phone. Furthermore, the another non-contact communication device is, for example, a reader/writer 140 in a non-contact communication system.

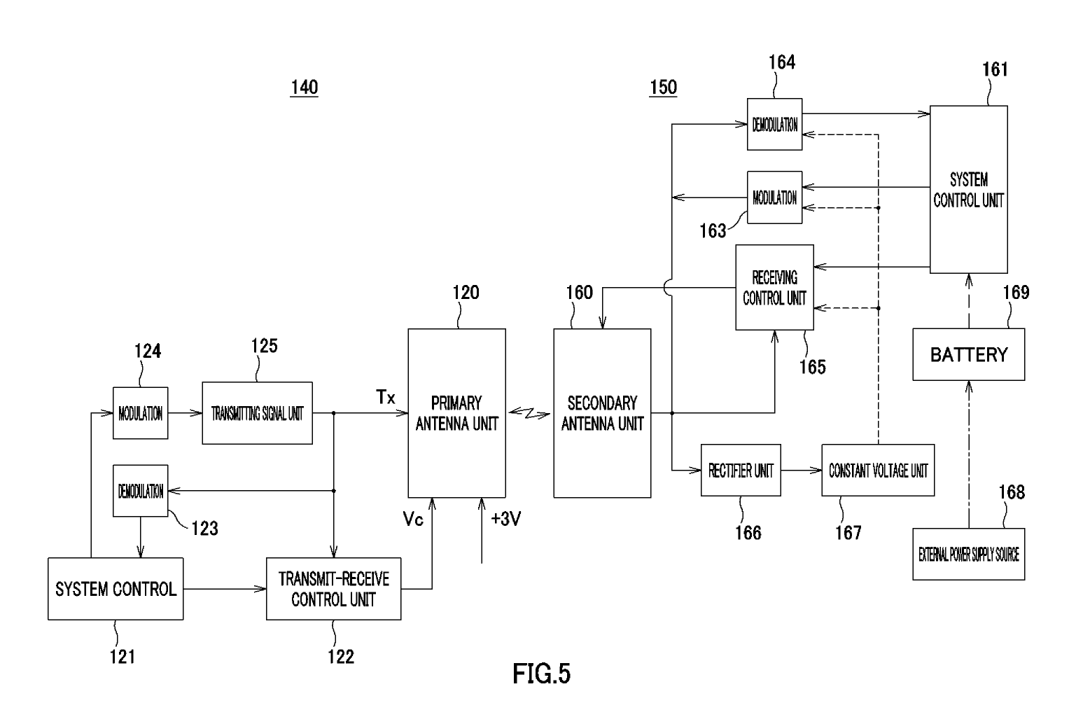

As illustrated in FIG. 5, the non-contact communication module 150 is provided with a secondary antenna unit 160 including a resonant circuit comprising a resonant capacitor and a coil module 10 functioning as a resonant coil. To use an alternating current signal transmitted from the reader/writer 140 as a power source for each block, the non-contact communication module 150 is provided with: a rectifier unit 166 configured to rectify the alternating current signal and convert into direct current power; and a constant voltage unit 167 configured to produce a voltage corresponding to the each block. The non-contact communication module 150 is provided with a demodulation unit 164, a modulation unit 163, and a receiving control unit 165, each being operated by direct current power supplied by the constant voltage unit 167, and furthermore, the non-contact communication module 150 is provided with a system control unit 161 configured to control the overall operation. A signal received in the secondary antenna unit 160 is converted into direct current power by the rectifier unit 166 and demodulated by a demodulator, and transmit data from the reader/writer 140 are analyzed by the system control unit 161. Furthermore, transmit data of the non-contact communication module 150 are produced by the system control unit 161, and, by the modulation unit 163, the transmit data are modulated into a signal to transmit to the reader/writer 140 and transmitted via the secondary antenna unit 160. The receiving control unit 165 is capable of producing a signal to make adjustment of a resonance frequency of the secondary antenna unit 160, based on the control by the system control unit 161, and adjusting the resonance frequency in accordance with a communication condition.

Furthermore, the reader/writer 140 of a non-contact communication system is provided with a primary antenna unit 120 including a resonant circuit having a coil module 10 and a variable capacity circuit comprising a resonant capacitor. The reader/writer 140 is provided with: a system control unit 121 configured to control the operations of the reader/writer 140; a modulation unit 124 configured to modulate a transmitting signal, based on an instruction from the system control unit 121; and a transmitting signal unit 125 configured to transmit a carrier signal to the primary antenna unit 120, the carrier signal having been modulated by the transmitting signal from the modulation unit 124. Furthermore, the reader/writer 140 is provided with a demodulation unit 123 configured to demodulate the modulated carrier signal transmitted by the transmitting signal unit 125.

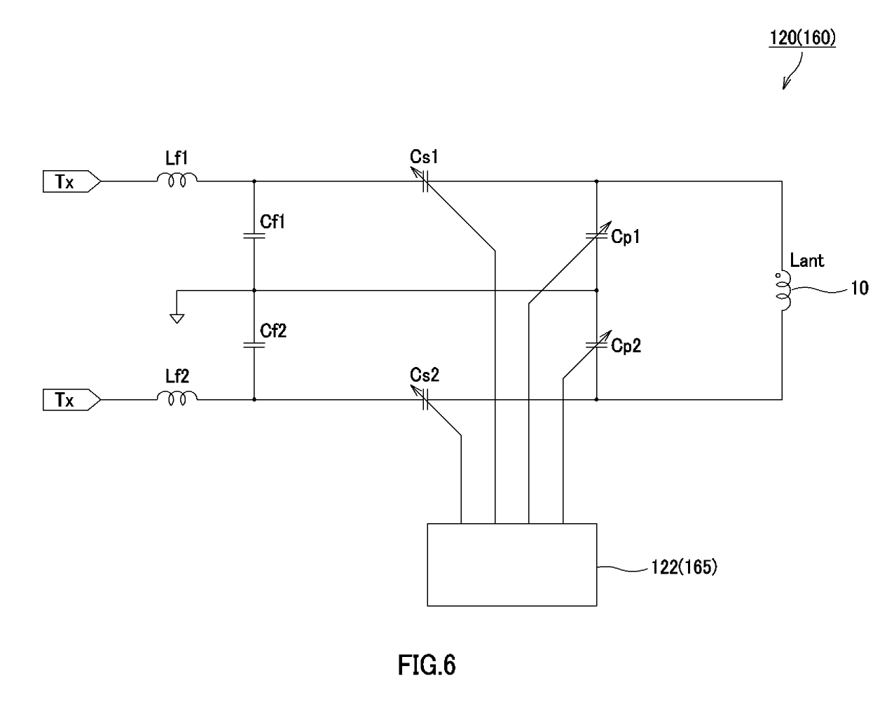

FIG. 6 illustrates a configuration example of the secondary antenna unit 160. The secondary antenna unit 160 includes a series-parallel resonant circuit comprising: variable capacitors CS1, CP1, CS2, and CP2, which constitute a resonance capacity; and the coil module 10 to form an inductance. The primary antenna unit 120 has the same configuration as that of the secondary antenna unit 160.

In each of the capacitors CS1, CP1, CS2, and CP2 in the variable capacity circuit, a direct current bias voltage is controlled by the receiving control unit 165 (in the case of the reader/writer 140, a transmit-receive control unit 122), an appropriate capacitance value is set, and a resonance frequency is adjusted together with a resonance frequency of the coil module 10 (Lant).

<Operation of Non-Contact Communication Device>

Next, there will be described the operations of the reader/writer 140 and the non-contact communication module 150 which are equipped respectively with the primary antenna unit 120 and the secondary antenna unit 160, each comprising a resonant circuit including the coil module 10.

The reader/writer 140 performs impedance matching with the primary antenna unit 120, based on a carrier signal transmitted by the transmitting signal unit 125, and makes adjustment of a resonance frequency of the resonant circuit, based on a reception condition of the non-contact communication module 150 on a receiving side. In the modulation unit 124, a modulation technique to be used for common reader/writers is employed, and an encoding technique, such as Manchester encoding technique and ASK (Amplitude Shift Keying) modulation technique, is employed. In the reader/writer 140, a carrier frequency is typically 13.56 MHz.

Based on a carrier signal transmitted, the transmit-receive control unit 122 monitors a transmission voltage and a transmission current, thereby controlling a variable voltage Vc of the primary antenna unit 120 so as to achieve impedance matching, whereby an impedance adjustment is made.

A signal transmitted from the reader/writer 140 is received in the secondary antenna unit 160 of the non-contact communication module 150, and the signal is demodulated by the demodulation unit 164. The contents of a demodulated signal are read by the system control unit 161, and, based on the results, the system control unit 161 produces a response signal. It should be noted that the receiving control unit 165 is capable of adjusting a resonance parameter and the like of the secondary antenna unit 160, based on the amplitude of a received signal and voltage and current phases, and thereby making adjustment of a resonance frequency so as to attain an optimal reception condition.

In the non-contact communication module 150, a response signal is modulated by the modulation unit 163, and the signal is transmitted to the reader/writer 140 by the secondary antenna unit 160. In the reader/writer 140, the response signal received in the primary antenna unit 120 is demodulated by the demodulation unit 123, and, based on demodulated contents, necessary processing is carried out by the system control unit 121.

<Configuration Examples of Non-Contact Charging Device and Power Receiving Device>

A resonant circuit including the coil module 10 according to the present invention can constitute a power receiving device 190 configured to charge a secondary battery built in a portable terminal, such as a cellular phone, in a non-contact manner by a non-contact charging device 180. As a non-contact charging system, an electromagnetic induction system, a magnetic resonance system, or the like can be applicable.

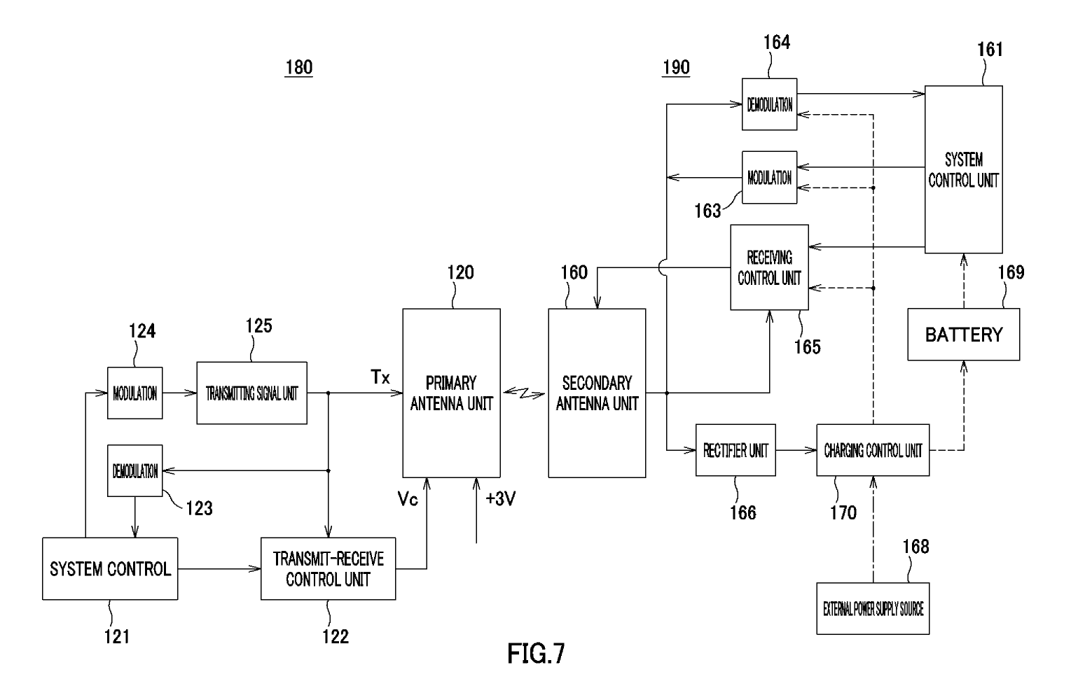

FIG. 7 illustrates a configuration example of a non-contact charging system comprising: a power receiving device 190, such as a portable terminal, which adopts the present invention; and a non-contact charging device 180 configured to charge the power receiving apparatus 190 in a non-contact manner.

The power receiving device 190 has almost the same configuration as the foregoing non-contact communication module 150 has. Furthermore, the configuration of the non-contact charging device 180 is almost the same as that of the foregoing reader/writer 140. Therefore, blocks of the reader/writer 140 and the non-contact communication module 150 each of which has the same function as a corresponding one of the blocks illustrated in FIG. 5 are assigned the same reference numerals as those in FIG. 5. Here, in the reader/writer 140, in many cases, a carrier frequency transmitted or received is 13.56 MHz, on the other hand, in the non-contact charging device 180, a carrier frequency is sometimes 100 kHz to a few hundreds of kHz.

Based on a carrier signal transmitted by the transmitting signal unit 125, the non-contact charging device 180 performs impedance matching with the primary antenna unit 120, and, based on a reception condition of the non-contact communication module on a receiving side, the non-contact charging device 180 makes adjustment of a resonance frequency of a resonant circuit.

Based on a carrier signal transmitted, the transmit-receive control unit 122 monitors a transmission voltage and a transmission current, thereby controlling a variable voltage Vc of the primary antenna unit 120 so as to achieve impedance matching, whereby an impedance adjustment is made.

The power receiving device 190 is configured such that a signal received in the secondary antenna unit 160 is rectified in the rectifier unit 166, and in accordance with the control of a charging control unit 170, the battery 169 is charged with a rectified direct current voltage. Even in the case where no signal is received in the secondary antenna unit 160, the charging control unit 170 is driven by an external power supply source 168, such as an AC/DC adaptor, whereby the battery 169 can be charged.

A signal transmitted from the non-contact charging device 180 is received in the secondary antenna unit 160, and the signal is demodulated by the demodulation unit 164. The contents of a demodulated signal are read by the system control unit 161, and, based on the results, the system control unit 161 produces a response signal. It should be noted that the receiving control unit 165 is capable of adjusting a resonance parameter and the like of the secondary antenna unit 160, based on the amplitude of a received signal and voltage and current phases, and thereby making adjustment of a resonance frequency so as to attain an optimal reception condition.

### Examples

### Characteristics Evaluation of Coil Module 10 According to the First Embodiment

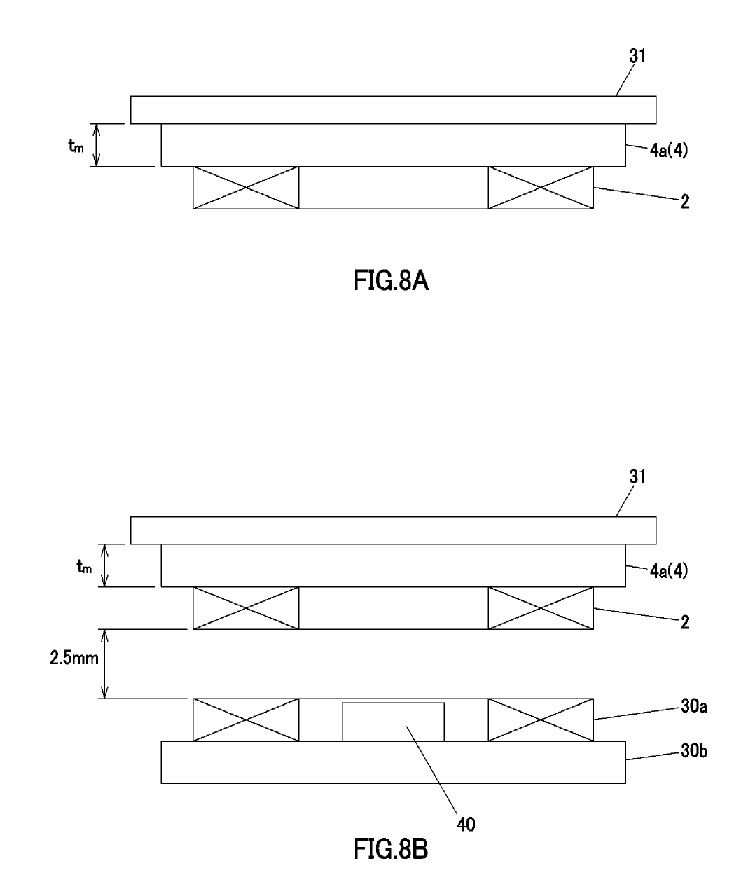

The characteristics of the coil module 10 according to the first embodiment of the present invention were evaluated by being considered as the influence of magnetic saturation on an inductance value of a coil. Here, the evaluation was carried out on the supposition of the use of a coil for non-contact electric supply. FIG. 8A and FIG. 8B illustrate the configurations of evaluation coils at the time of measurements.

FIG. 8A illustrates the configuration of a power receiving coil unit to evaluate a state in which an external direct-current magnetic field is absent. The power receiving coil unit is the coil module 10 according to one embodiment of the present invention, and comprises a spiral coil 2 and a magnetic resin layer 4a. A metal plate 31 mimicking a battery pack was disposed on a surface of the magnetic resin layer 4a, the surface opposite to a surface on which the spiral coil 2 was mounted. The power receiving coil unit was a 14-turn rectangular coil (outside diameter: 31×43 mm).

FIG. 8B illustrates the configuration of a power receiving coil unit to evaluate a state in which an external direct-current magnetic field generated by a magnet is present. As is the case with FIG. 8A, the power receiving coil unit is the coil module 10 according to one embodiment of the present invention, and comprises a spiral coil 2 and a magnetic resin layer 4a. A metal plate 31 mimicking a battery pack was disposed on a surface of the magnetic resin layer 4a, the surface opposite to a surface on which the spiral coil 2 was mounted. A power transmission coil unit was arranged so as to face the power receiving coil unit (the coil module 10). The power transmission coil unit comprises a spiral coil 30a and a magnetic shield material 30b, and was arranged so that the central axis of the power transmission coil unit was aligned with the center of the power receiving coil unit. At the center of the power transmission coil unit 30, a magnet 40 to generate a direct-current magnetic field was arranged. The transmitting coil unit equipped with this magnet was produced based on Design A1 described in Non-patent document 2. Between the power receiving coil unit and the power transmission coil unit, an acrylic plate having a thickness of 2.5 mm was disposed to set a certain clearance. For each of the cases of FIG. 8A and FIG. 8B, with changing the configuration of the magnetic resin layer 4a, inductance values of the respective coils were measured using an impedance analyzer 4294A manufactured by Agilent Technologies.

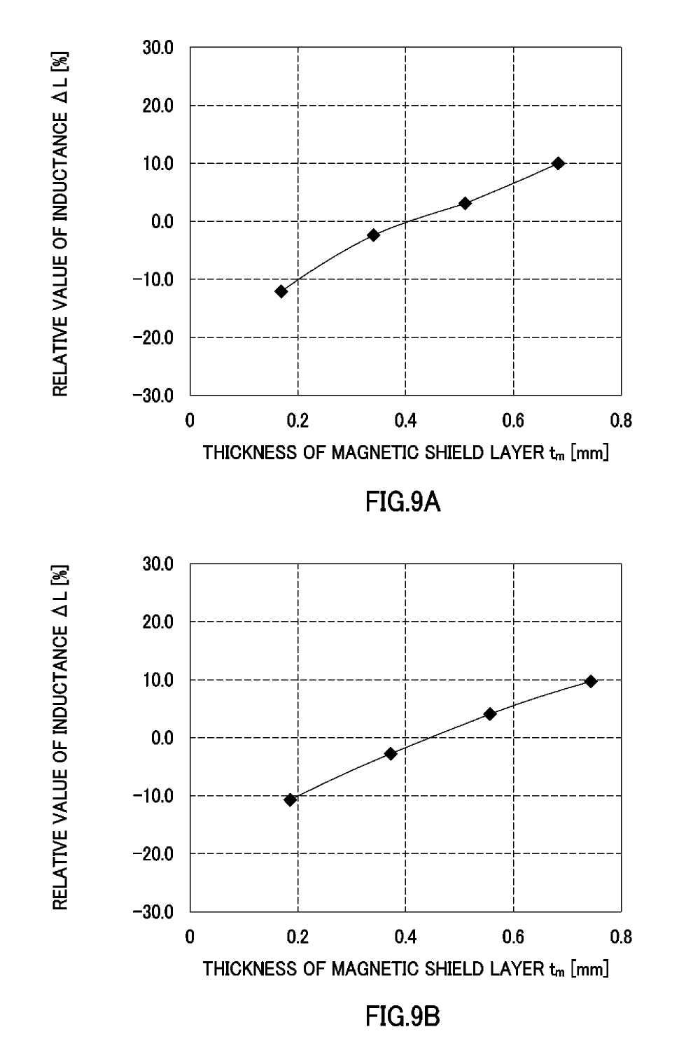

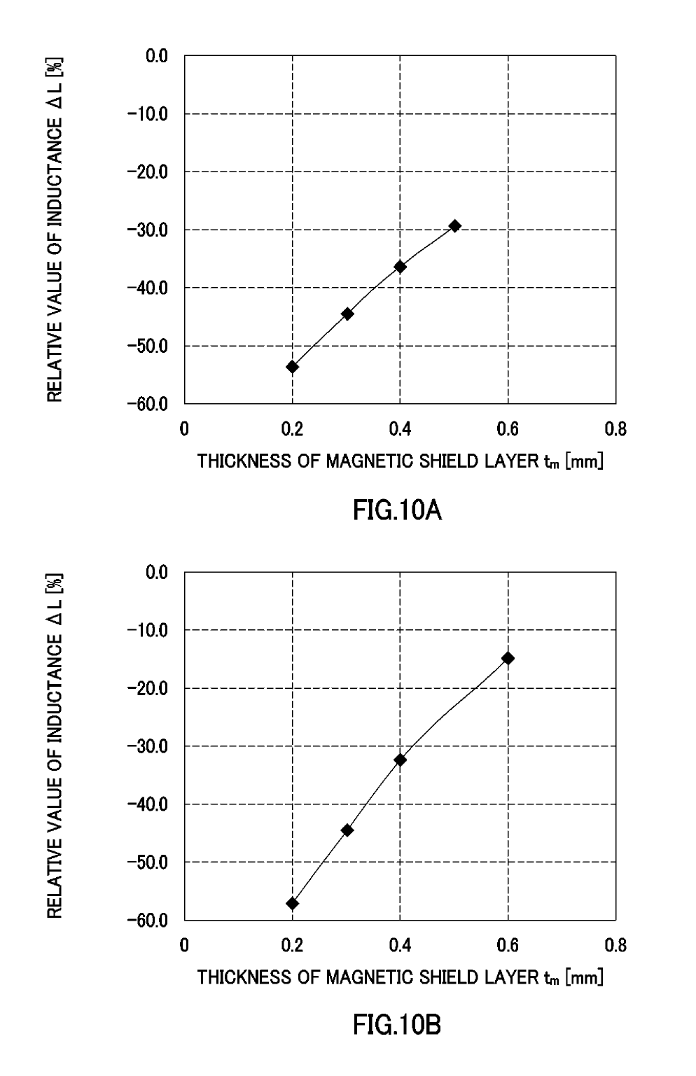

FIG. 9 and FIG. 10 show measured inductance values of a power receiving coil unit equipped with a magnetic shield layer made of various magnetic materials. The amount of change in a measured inductance value in a state in which a direct-current magnetic field is present with respect to a measured inductance value in a state in which a direct-current magnetic field is absent is expressed by percentage, and called a relative value of inductance. With changing the thickness, tm, of a magnetic shield layer, relative values of inductance were plotted. A negative relative value of inductance suggests a decrease in inductance value, and a positive relative value suggests an increase in inductance value.

### Example 1

FIG. 9A shows relative values of inductance obtained when a magnetic resin layer 4a which contained a spherical amorphous powder having a dimensional ratio (the major diameter/the minor diameter) of not more than 6 and had an average magnetic permeability of approximately 20 was used as a magnetic shield layer.

### Example 2

FIG. 9B shows relative values of inductance obtained when a magnetic resin layer 4a which contained a spherical sendust powder having a dimensional ratio (the major diameter/the minor diameter) of not more than 6 and had an average magnetic permeability of approximately 16 was used as a magnetic shield layer.

### Comparative Example 1

FIG. 10A shows relative values of inductance obtained when, as a magnetic shield layer, there was used a magnetic sheet which was produced by mixing a sendust flat powder having a dimensional ratio (the major diameter/the minor diameter) of approximately 50 with a binder and had an average magnetic permeability of approximately 100.

### Comparative Example 2

FIG. 10B shows relative values of inductance obtained when Mn—Zn bulk ferrite having a magnetic permeability of approximately 1500 was used as a magnetic shield layer.

### Results

As shown in FIG. 9A and FIG. 9B, in the configuration examples of the embodiment of the present invention in which a magnetic resin layer 4a containing a spherical magnetic powder was used as a magnetic shield layer, an inductance value of the coil did not decrease much even when a direct-current magnetic field was applied. The reason why an inductance value became positive is that the magnetic shield layer constituting the power transmission coil unit was large, and accordingly magnetic flux converged in the vicinity of the power receiving coil unit.

On the other hand, as shown in FIG. 10A, in the case where the magnetic sheet made of a flat-shape magnetic powder was used as a magnetic shield layer, a direct-current magnetic field of the magnet mounted on the transmitting coil unit influenced magnetic saturation to occur in the magnetic shield layer, whereby an inductance value considerably decreased. It is shown that, as the shield layer is thinner, magnetic saturation is more easily caused, and accordingly, this trend is increasingly apparent.

As shown in FIG. 10B, when ferrite was used as a magnetic shield layer, as is the case with FIG. 10A, an inductance value considerably decreased.

Thus, the configuration of the present invention allows the amount of change in coil inductance to be smaller in the transmitting coil unit equipped with a magnet, or in an environment in which a large direct-current magnetic field is present, and hence, the configuration of the present invention makes it possible to achieve a smaller change in resonance frequency of a power receiving module and stable power transfer.

### Characteristics Evaluation of Coil Module 20 According to the Second Embodiment

A power receiving coil unit which was the same as that used in the foregoing evaluation of the coil module 10 and illustrated in FIG. 8A and FIG. 8B was used. The power receiving coil unit was a 14-turn rectangular coil (outside diameter: 31×43 mm).

The characteristics evaluation was performed in such a manner that there were measured an inductance value of a coil in the case where the magnetic resin layer 4a was used alone as the magnetic shield layer 4, and an inductance value of a coil in the case where the magnetic layer 4b having a thickness of 50 μm was stuck on the undersurface of the magnetic resin layer 4a. Furthermore, in each of the cases, inductance values were measured with changing the thickness of the magnetic resin layer 4a. Thus, the total thickness of the magnetic shield layer 4 was obtained by adding the thickness of the magnetic layer 4b of 50 μm to the thickness of the magnetic resin layer 4a.

### Example 3

As a magnetic resin layer 4a of a power receiving coil unit (coil module 20) for evaluation, there was used a material which contained a spherical amorphous powder having a dimensional ratio of not more than 6 and had an average magnetic permeability of approximately 30, and, as a magnetic resin layer 4b, there was used a material which was produced by mixing a sendust flat powder having a dimensional ratio of approximately 50 with a binder and had an average magnetic permeability of approximately 100.

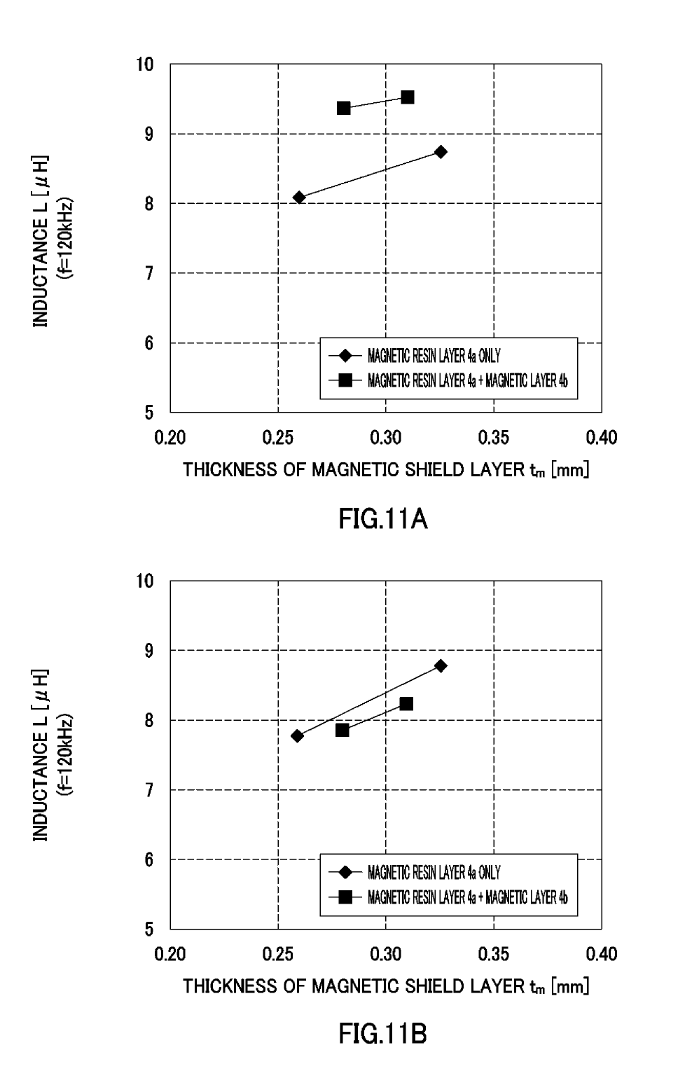

FIG. 11A and FIG. 11B are graphs on which inductance values L are plotted relative to the thickness, tm, of the magnetic shield layer 4. It should be noted that the inductance values were measured using an impedance analyzer 4294A manufactured by Agilent Technologies, and plotted as inductance values at a frequency of 120 kHz, which is commonly used in non-contact charging systems.

FIG. 11A shows results of measuring inductance values of a coil in the case where a direct-current magnetic field was not applied, that is, in the case of adopting the configuration of the power receiving coil unit illustrated in FIG. 8A. FIG. 11B shows results of measuring inductance values of a coil in the case of adopting the configuration of the power receiving coil unit illustrated in FIG. 8B in which a direct-current magnetic field was applied by a magnet.

### Results

As shown in FIG. 11A, the replacement of a part of the magnetic resin layer 4a by the thin magnetic layer 4b enabled an inductance value of a coil to be improved.

On the other hand, as shown in FIG. 11B, when a direct-current magnetic field was applied by a magnet, the influence of magnetic saturation was greater, whereby an inductance value decreased in each of the coils. The magnetic layer 4b has a higher effect of increasing inductance than the magnetic resin layer 4a, but, on the contrary, under a condition where a strong magnetic field is applied, the magnetic resin layer 4a has a higher effect of increasing inductance, and hence, an adjustment of a ratio of the foregoing two layers makes it possible that coil inductance, which has a great influence on a magnetic shield property and resonance conditions of a circuit, and magnetic saturation characteristics of the coil are adjusted so as to achieve desired performance.

As mentioned above, the coil module of the present invention has a magnetic resin layer which is resistant to magnetic saturation, and therefore, even under an environment in which a strong magnetic field is applied, the amount of change in coil inductance is small and electric power can be stably supplied. Furthermore, adjustments of the thickness of the magnetic resin layer and the thickness of the magnetic layer make it possible to adjust a balance between the magnitude of coil inductance and the rate of change in coil inductance under a strong magnetic field environment.

### Reference Symbols

1 . . . lead wire, 2 . . . spiral coil, 3a, 3b . . . drawn-out portion, 3c, 3d . . . terminal portion, 4 . . . magnetic shield layer, 4a . . . magnetic resin layer, 4b . . . magnetic layer, 5 . . . adhesive layer, 10, 10a, 10b, 20 . . . coil module, 21 . . . notch portion, 30 . . . transmitting coil unit, 30a . . . spiral coil, 30 . . . magnetic shield, 31 . . . metal plate, 40 . . . magnet, 120 . . . primary antenna unit, 121 . . . system control unit, 122 . . . transmit-receive control unit, 123 . . . demodulation unit, 124 . . . modulation unit, 125 . . . transmitting signal unit, 140 . . . non-contact communication device, 150 . . . non-contact communication module, 160 . . . secondary antenna unit, 161 . . . system control unit, 163 . . . modulation unit, 164 . . . demodulation unit, 165 . . . receiving control unit, 166 . . . rectifier unit, 167 . . . constant voltage unit, 168 . . . external power supply source, 169 . . . battery, 170 . . . charging control unit, 180 . . . non-contact charging device, and 190 . . . power receiving device.

1. A coil module, comprising:
a magnetic shield layer containing a magnetic material; and
a spiral coil,
wherein the magnetic shield layer includes at least one magnetic resin layer containing magnetic particles, and
wherein the magnetic resin layer contains magnetic particles having a spherical shape or a spheroid shape having a dimensional ratio of not more than 6, the dimensional ratio being expressed as a ratio of a major diameter to a minor diameter.

2. The coil module according to claim 1, wherein the magnetic shield layer further includes a magnetic layer containing a magnetic material having a magnetic property different from a magnetic property of the magnetic resin layer.

3. The coil module according claim 1, wherein the magnetic resin layer contains a metal magnetic powder, a resin, and a lubricant, and is a dust core obtained by applying compression molding to a mixture of the metal magnetic powder, the resin, and the lubricant.

4. The coil module according to claim 1, wherein the magnetic resin layer is formed by kneading the magnetic particles and a resin, thereby having pliability.

5. The coil module according to claim 1, wherein the magnetic shield layer accommodates a terminal of the spiral coil, the terminal protruding in a thickness direction of said coil module.

6. The coil module according to claim 1, wherein the spiral coil comprises a coil having a conductive layer pattern formed on at least one surface of a substrate.

7. The coil module according to claim 1, wherein, on an inside diameter side or of an outside diameter side of the coil module, another coil module is provided.

8. An antenna device, comprising the coil module according to claim 1.

9. An electronic device, comprising the coil module according to claim 1.
